(19) United States
(12) Patent Application Publication
(10) Pub. No.: US 2002/0010563 A1
(43) Pub. Date: Jan. 24, 2002

(54) METHOD FOR ACHIEVING AND VERIFYING INCREASED PRODUCTIVITY IN AN INDUSTRIAL PROCESS

(76) Inventors: S. MICHAEL RATTEREE, CHESTERFIELD, MO (US); JOHN B. DUFFY, CHESTERFIELD, MO (US)

Correspondence Address: CHARLES E DUNLAP, HOWELL & HAFERKAMP LC, 7733 FORSYTH BOULEVARD, SUITE 1400, ST LOUIS, MO, 63105

(21) Appl. No.: 09/333,615

(22) Filed: Jun. 15, 1999

(51) Int. Cl. G06F 17/10

(52) U.S. Cl. 703/2

(57) ABSTRACT

A method for improving the productivity of an industrial process includes the steps of using a computer to derive a statistical mathematical model that describes a productivity-related parameter, such as energy use, consumables use, or production rate, in terms of a validated set of independent variables. A modification that will improve the productivity of the process is identified and implemented and the model is used to measure the change in the productivity-related parameter caused by the modification. Measurement of the change is carried out by determining the difference between a measured value of the productivity-related parameter and a value of the parameter predicted by the model using measured values of the independent variables that are included in the validated set.

### BACKGROUND OF THE INVENTION

1. Field of the Invention

The present invention relates to a method for improving the productivity of an industrial process and measuring the improvement, and more particularly to a method for improving the productivity of an industrial process and measuring the improvement by deriving and using a statistical mathematical model to select and measure the impact of modifications on the productivity of the process.

2. Description of the Related Art

Although owners and operators of industrial processes constantly look for ways to minimize processing costs and improve processing efficiency, their main focus is usually on maintaining production rate and quality to meet market demands. Often they find it difficult to justify time and expense to analyze secondary, or collateral, problems, such as how to improve energy efficiency, use of labor, or the efficiency of use of consumables and raw materials and the like. Thus, opportunities for improvement in these collateral areas often are not sought. Moreover, even if these collateral opportunities are identified, capital and/or operating expenditures necessary for their implementation often cannot be justified in view of competing needs for capital.

Recently, private companies have been formed for the purpose of developing, installing and financing projects designed to improve the energy efficiency and reduce the maintenance costs for facilities. These companies, termed “energy service companies”, or “ESCO's”, typically contract with a host facility to survey opportunities for saving energy in areas such as high efficiency lighting, high efficiency heating, ventilating and air conditioning (HVAC), efficient motors and variable speed drives and centralized energy management systems. An unique feature of ESCO's is their provision of performance-based contracting, in which the ESCO's compensation for a project, and sometimes the project financing, is directly linked to the amount of energy that is actually saved. More information on the subject of ESCO's and their operation can be found in the publication What is an ESCO? (available on May 21, 1999, at the website: www.naesco.org). Further information on the methods for measuring and verifying the energy savings that flow from ESCO projects can be found in Measurement and Verification (M&V) Guidelines for Federal Energy Projects, a report prepared for ESPC Working Group, Federal Energy Management Program (FEMP), by Schiller Associates, Oakland Calif., Feb. 1996.

Thus far, the application of the methods used by ESCO's have been limited to the fields of lighting; HVAC; and the like and have not been applied to the more complex field of industrial processes. Even though a great deal of energy is consumed by industrial processes in the United States, lighting and HVAC in the commercial and institutional markets also consume a great deal of energy and are more visible to ESCO's, because they are important at a far higher number of commercial and institutional installations. Thus, ESCO's have focused their efforts on the largest and most widespread market for their services—lighting and HVAC. Another reason why the methods used by ESCO's have not been applied to industrial processes is the markedly greater complexity of an industrial process as compared with a lighting or HVAC installation. This added complexity is indicated by the significantly larger number of independent variables that are present for industrial processes than are encountered in the less complex environmental systems. Techniques developed for measuring the savings resulting from modifications to non-industrial applications cannot simply be applied to measure the savings that are the result of modifications of more complex industrial process systems, because the ESCO techniques lack sufficient accuracy and dependability when applied to complex industrial processes.

One example of a typical energy conservation system is described in U.S. Pat. No. 4,990,893, to Kiluk, which discloses a method for an alarm system in which energy use in apartments and the like is monitored over a period of time to provide an average distribution pattern. Subsequent actual energy use is compared versus the average distribution pattern and an alarm is activated if the average and actual distribution patterns differ by a predetermined amount. In the method of Kiluk, time is the only independent variable that is considered and no provision is made for variations in environmental conditions, activity within the apartment, or other common variables that can affect energy use, but are independent of time. Thus, the method of Kiluk would result in an energy savings calculation of very low accuracy if applied to an industrial process having many independent variables such as processing rate, environmental temperature, type of fuel used, type of raw materials or reactants used, and the like. Accordingly, it would be useful to provide a method for measuring energy use for an industrial process, specifically energy savings due to modifications or changes, which would take into account common independent variables.

Another example can be found in U.S. Pat. No. 5,717,609, to Packa et aL., where a method is disclosed for measuring energy savings due to a retrofit of the type where some part of the baseline (non-retrofitted) environment is preserved and can be used to measure baseline energy transfer parameters. By simultaneously measuring heat transfer in the baseline environment and the retrofitted environment, the difference between the two indicates the savings due to the retrofit. However, the Packa et al. method cannot be used in situations where no part of the baseline environment can be preserved, such as, for example, with a change in fuel, or a change in energy transfer equipment, because there is no way to measure heat transfer in the baseline environment. Thus, it would be useful to provide a method that could monitor and report energy savings due to modifications or changes in the system or process of interest that do not preserve any part of the non-retrofitted, baseline, environment. Furthermore, it would be useful if the method could also determine and show the operating characteristics of the process—such as whether the process was statistically in control and/or define any trends in process productivity for the process.

Industrial processes typically use the input of certain amounts of energy, labor, consumables, raw materials and the like to produce products at a certain rate. The amount of product that can be produced per unit of input is termed the “productivity” of the process. Productivity can be expressed on the basis of energy, labor, consumables, raw materials, and the like, as mentioned above, but also on the basis of the amount of capital invested in the process, or on the size of the process equipment, or even another basis. Since most industrial processes produce some type of product, the productivity can be expressed as, for example, number of units of product produced (“production”) per unit of time (“production rate”). Common productivity parameters include production per unit of energy use, production per unit of labor, production per unit of equipment size, production per unit of invested capital, and the like. An advantage of the parameter of productivity is that it permits one to measure the operating efficiency of the process as a function of some particular basis: i.e., energy use, labor, consumables use, or the like. The inverse of the productivity function—i.e., energy use per unit of production—, or any parameter that is directly or inversely proportional to productivity, will also serve the same purpose of measuring productivity.

Owners and operators of industrial processes compete with others who produce the same products and sell to the same market. It is important to minimize the cost of their process and products in order to improve their competitive position. One method of reducing processing costs is by finding and implementing modifications to the process that increase the productivity of the process. An example can be provided by process energy use. Any modification to the process or its operation that reduces the amount of energy used per unit of production will improve the production per unit of energy use and, ultimately, can reduce the cost per unit of product and place the owners and operators in a better position relative to their competitors. Since companies generally seek to maximize profitability, minimizing cost is a valuable means for accomplishing that end.

However, problems remain that hamper the efforts to increase productivity in industrial processes. Problems remain in how to identify a modification that would improve the productivity of an industrial process, and—after a potential modification is identified—how to systematically and accurately measure the change in productivity of the process that was caused by the modification, rather than by changes in variables that are unrelated to the modification. How to shift the risk of performance of the modified process from the owner/operator of the process to a party more capable of controlling the risk—both for capital costs and for operating costs—remains a difficulty. A further problem is how to provide the owner/operator of the process with information that could be used in the management of the process as to whether the process was statistically in control and/or to define the trend in process productivity for the process.

### BRIEF SUMMARY OF THE INVENTION

Briefly, therefore, the present invention is directed to a novel method for improving the productivity of an industrial process comprising the steps of: deriving with a computer a statistical mathematical model that describes a productivity-related parameter for the industrial process in terms of a validated set of independent variables; identifying a modification to improve the productivity of the process; implementing the modification; and measuring the change in the productivity-related parameter caused by the modification by determining the difference between a measured value of the parameter and a value of the parameter predicted by the model using measured values of each of the independent variables of the validated set.

Among the several advantages found to be achieved by the present invention, therefore, may be noted the provision of a method to identify a modification that would improve the productivity of an industrial process; the provision of such a method that is capable of systematically and accurately measuring the change in productivity of the process that was caused by the modification, rather than by changes in variables that are unrelated to the modification; the provision of such a method that shifts the risk of performance of the modified process from the owner/operator of the process to the contractor who recommended and implemented the modification—both for capital costs and for operating costs; and the provision of such a method that also provides the owner/operator of the process with information as to whether the process is statistically in control and/or to define the trend in process productivity for the process.

### BRIEF DESCRIPTION OF THE SEVERAL VIEWS OF THE DRAWINGS

FIG. 1 is a block diagram of the steps for deriving a statistical mathematical model of the present invention;

FIG. 2 is a block diagram of the steps for one embodiment of the application of the statistical mathematical model of the present invention;

FIG. 3 is a plot of the actual natural gas use for a steel works and the natural gas use as predicted by a statistical mathematical model;

FIG. 4 is a plot of the daily gas savings (predicted-actual energy use) for a tube mill as a function of time; the plot also shows the variation in energy savings compared with 1, 2 and 3 standard deviations from the process average for the purpose of using the plot as a statistical process control chart; and

FIG. 5 is a plot of actual and predicted natural gas usage as a function of time for a tube mill furnace showing the effect on energy usage of the implementation of a modification of the furnace control system.

### DETAILED DESCRIPTION OF THE INVENTION

In accordance with the present invention, it has been discovered that the energy use, use of consumables, production rate, and other productivity-related parameters for an industrial process can be improved by deriving a mathematical model of the particular productivity-related parameter of interest and using the model to measure the improvement that results from a modification to the process. The model is a statistical mathematical model that is derived by using a computer. A key feature of the model is that it describes the productivity-related parameter of interest in teams of a validated set of independent variables (as those terms are defined below). After a modification to improve the productivity of the process is identified and implemented, the change in the productivity-related parameter caused by the modification is measured by determining the difference between a measured value of the parameter and a value of the parameter predicted by the model using measured values of each independent variable of the validated set.

The present invention has been found to be particularly useful for application to industrial processes that consume energy and other consumables during the transformation of raw materials to a finished product. As used herein, an “industrial process” is distinguished from a heating, ventilating and air conditioning system, or a lighting system, or a small collection of simple devices such as pumps and the like, on the basis that most of the energy that is used by the process is used to carry out the transformation of raw material to finished product, rather than to control, environmental conditions.

The typical industrial process is composed of one or more unit processes that are combined into a system within which the transformation takes place. It is more common that the industrial process includes more than two or three unit processes and often includes over ten, or more. Depending upon the type of industrial process, these unit processes can be, for example-but without limitation: furnaces, molding systems, mixers, pelletizers, mills, grinders, heat exchangers, presses, distillation columns, reactors, boilers, filters, waste treatment systems, and the like. It is common for the unit processes to be combined by interconnecting them with pipes, hoses, conveyors, slides, and the like, to form a complete and interconnected process for the transformation of a raw material to a finished product.

The industrial process can be owned by an owner and operated by an operator, and in many cases the owner and the operator are the same entity. The term “owner” will be used herein to describe both the owner and/or the operator of the industrial process. Unless specified otherwise, the steps of the method of the present invention can be performed by the owner, or they may be performed by a contractor. When the steps are carried out by a contractor, it is preferred that the contractor is unrelated to the owner or the operator in a legal sense—that is, the contractor is not an employee, division, subsidiary, parent, or other entity that is legally related to the owner or operator, but is preferably an independent contractor. It is also preferred that the contractor have engineering skills, and more preferred that the contractor have engineering, management consulting and industrial development investing skills. As will become apparent, it is an advantage that the contractor perform some of the steps of the subject method. When a contractor is involved in carrying out one or more of the steps of the subject method, the owner may be termed the “client”.

Among the advantages of having an independent contractor perform some or all of the steps of the subject method is that an independent contractor can bring increased objectivity to the work. Moreover, process owners often cannot justify the time and/or expense of analyzing productivity improvements, such as reducing energy use, or of borrowing funds for energy saving improvements, because such projects are collateral to their main manufacturing business. And, even if such projects are considered, they almost always have a lower priority than projects that more directly impact their manufacturing process. Since time and funds are almost always limited, such projects are often postponed or not undertaken by a typical manufacturer. Furthermore, if the contractor is financially independent of the owner/operator, it can borrow funds without affecting the owner/operator's balance sheet. Thus, participation of a contractor, whose primary task is to design, finance and implement such energy-saving projects, advantageously permits such manufacturers to undertake such improvements and to enjoy the benefits.

Deriving a Statistical Model

One step of the present method is to derive a statistical mathematical model that describes a productivity-related parameter for the industrial process in terms of a validated set of independent variables. As used herein, the terms “statistical mathematical model” refer to a model that is a best-fit model for a given set of data. Due to the large amount of data that must be gathered and processed in order to effectively model an industrial process, it is preferred that the derivation of a model be carried out by a computer. Once the model has been derived, it can be applied by hand calculations. However, it is preferred that the application of the model is also carried out by a computer in order to increase the speed and accuracy of computation.

As discussed previously, the productivity of an industrial process can be expressed on the basis of time, energy use, consumables use, labor, the amount of capital invested in the process, or on the size of the process equipment, or even another basis. Productivity per unit time is often expressed as, for example, number of units of product produced (“production”) per unit of time (“production rate”). Other productivity parameters include production per unit of energy use, production per unit of labor, production per unit of equipment size, production per unit of invested capital, and the like. The inverse of the productivity function—i.e., energy use per unit of production—, or any parameter that is directly or inversely related to productivity, such as energy use per unit period of time, will serve the same purpose of measuring productivity and can act as the productivity-related parameter. As used herein, the term “productivity-related parameter” is to be understood to include all commonly-used productivity parameters—including those listed above; the inverse of those conventional parameters; and all parameters that are inversely or directly related thereto. Thus, energy use per unit time, consumables use per unit time, or production per unit of time, are to be considered to be included as productivity-related parameters.

For the purpose of example, some of the description of the subject method herein will be in terms of productivity on the basis of energy (production per unit of energy use), or of the inverse parameter—energy use per unit of production, or energy use per unit of time. However, it is to be understood that when energy use is used as an example, similar methods and equations could be used to derive a model for any other productivity-related parameter, simply by substituting the appropriate variables and parameters.

Industrial energy consumption is a function of numerous contributing factors, caused by equipment that uses energy in response to demands placed on it by the user and according to its particular design. Energy efficiency improvements usually concentrate on individual parts or systems, while overall energy consumption is often analyzed by examining the use of energy in its specific fuel forms. Because independent variables affect consumption of these fuels, accurate comparisons of the energy consumption for time measured periods for a process must include the effect of each of these variables.

Reductions in industrial energy consumption typically result in energy cost savings. However, it should be recognized that energy cost can also be reduced by using energy at alternative times (e.g., during “off peak” hours), using alternative forms of energy (“fuel switching”), or negotiating more favorable utility rates.

In many cases, it is possible to determine the quantitative effects of one or more of the independent variables through a statistically valid regression analysis of historic data for the process. The regression model may be linear, or may be dependent upon other functions such as powers, time lead or lag, codependency or exponentials. The most common model is linear, but other dependencies are sometimes encountered.

The inventors have found that it is preferred to use a statistical mathematical model to predict and track energy performance for an industrial process for several reasons. First, the model can be used as a basis for measuring energy savings and for determining the share of savings that should go to the owner and to the contractor. Second, the model can be used as a valuable management tool for reducing energy costs on a day-to-day basis. And, third, the model can serve as a standard against which trends in the process' performance can be measured.

The modeling process includes the systematic identification of all of the special or assignable causes of variability in energy use and defining the contribution of each to changes in energy use. For example, it is intuitively known that energy use will generally increase when production rates increase, and that relationship should be built into the model by using a production rate coefficient(s). An accurate, reliable and repeatable model depends upon inclusion of all of the assignable causes of variation in energy use. One preferred characteristic of the validated set of independent variables of the present method is that the set includes all independent variables necessary to identify all of the special or assignable causes of variablity for the process.

Models of energy usage, or of any other productivity-related parameter, are developed using the statistical technique of multiple linear regression. The use of multiple linear regression analysis for the derivation of mathematical models is well known and additional information on the use of multiple linear regression techniques can be found in Introduction to the Practice of statistics, by David S. Moore and George P. McCabe, W. H. Freeman & Co. (1989); and Statistics, by David Freeman, et al., Second Ed., W. W. Norton & Co. Among the assumptions on which the multiple linear regression method depends are that a linear relationship exists between the independent variables and the dependent variable; the variables are normally distributed; and the observations used in the calibration sample, are independent. The assumptions of linearity and normality should be addressed by standard statistical tests and, if necessary, data transformations or smoothing techniques, as described in the references cited above, may be used to compensate for some instances of non-linearity and abnormality.

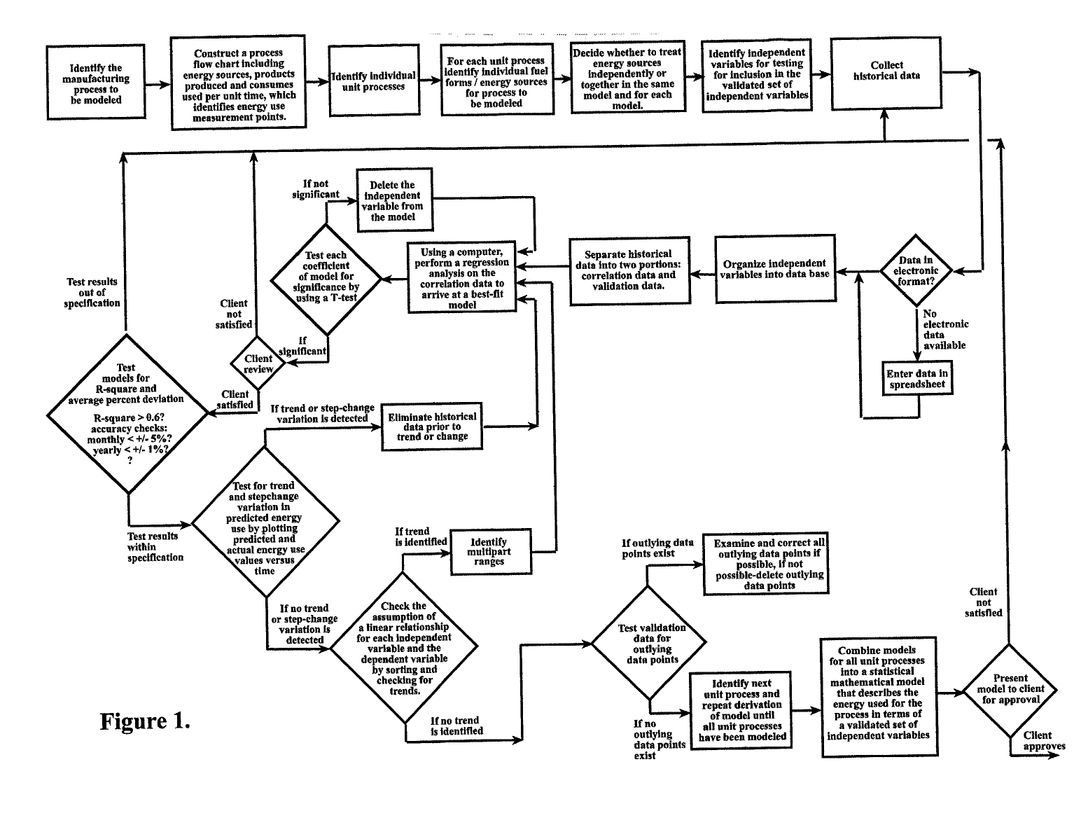

Some of the key steps that are used for the derivation of a statistical mathematical model that describes energy use per unit of production in terms of significant independent variables are shown in FIG. 1. It should be understood that the same method can be used for the derivation of a model for any productivity-related parameter, merely by substituting the appropriate dependent and independent variables. The overall process for deriving the model can be described as follows:

The industrial process that is to be modeled is identified and, preferably, a flow chart is constructed of the entire process. The flow chart should indicate main energy sources for the process, such as electricity, coal, oil, gas, water, steam, and the like. The chart should also indicate the products produced and, preferably, the volume of product(s) that is produced per unit time. It is also useful if the chart identifies energy consumption measurement points for the process; i.e., where and how energy use is measured.

Unit processes are selected and defined that will be segmented from the industrial process for modeling purposes. The unit processes, as described previously, are processing units that have been combined together to make up the process. It is preferable that the unit processes are defined in such a way that the boundaries between unit processes are clearly delineated. This clarifies the identification of an input stream, piece of equipment, or output stream with one certain unit process.

The following steps are then carried out for each of the unit processes.

1. The individual fuel forms/energy sources to be modeled (predicted) are identified.

2. Whether energy sources are to be treated independently or whether there are substitutions (i.e., alternative fuels like coke oven gas and natural gas) that must be modeled together, is decided. It is preferable to derive a separate model for each fuel source that is used in the unit process (i.e., natural gas, coal, steam, electricity, etc.) unless some internally-generated material (such as coke oven gas or refining light ends) is substituted in whole or in part for another external source of energy (such as natural gas), in which case, it is preferable to include both fuel sources in the same model.

3. Independent variables are identified for testing as potential members of the validated set of independent variables (e.g., production quantities, degree-days, production days, office days, days of the week, product mix, and the like). The criteria for inclusion and testing are that the independent variable be one that could potentially have an effect on the dependent variable (energy consumption) in the unit process and that sufficient data exists to test the validity of the variable. Historical data is collected for energy consumption and for each of the independent variables. Although monthly readings/records for two years can be used to test the variables, it is preferred that the data collected represent at least two years of daily readings and/or records, and to have been recorded since any major process change. It is more preferred that the data collected represent at least three years of daily readings and/or records, and to have been recorded since any major process change.

4. All of the potential independent variables that were identified in step 3 are organized into a database with one column (field) assigned to each variable, and one row (record) assigned to each daily or monthly reading. All independent variables for which data are available are incorporated into the database. It is preferred that from about 50 to about 150 independent variables are identified and included in the database. In order that the resulting analysis provides a model in which high confidence can be placed, it is preferred that there are more rows than columns in the database by a factor of about 10. For 100 independent variables, for example, this would require about 1,000 days of data—or the equivalent of about three years of operating data.

5. The data is separated into two portions—a portion to be used for the derivation of the mathematical model (the correlation data) and a portion to be used for verification of the accuracy of the model (the validation data: preferably data from the most recent 2 -3 months).

6. Using a computer, a regression analysis is performed using the correlation data for the dependent energy use variable versus the selected independent variables to obtain a regression model that describes the energy use for the unit process in terms of the selected independent variables, regression coefficients and constants. For each unit process, this model can have the form:

$${E}_{k} = {r}_{Bk} + {\sum }_{j = 1}^{i} {{r}_{kj} ( {V}_{j} )}^{m}$$

where:

Eₖ is the energy use for the k^{th} unit process per unit time;

r_{Bk} is a constant representing the base energy load for the k^{th} unit process per unit time;

Vⱼ is the j^{th} significant independent variable for the k^{th} unit process;

rₖⱼ is the linear regression coefficient for the j^{th} independent variable in the k^{th} unit process that provides the best fit in a correlation of the effects of Vⱼ upon Eₖ as determined by multiple regression analysis of historical data;

m is a best fit constant correlating the effect of Vⱼ upon Eₖ as determined by multiple regression analysis of historical data and is a fraction or whole number from 0 to about 3;

j is a number designating one of the significant independent variables in the k^{th} unit process and is an integer from 1 to i; and

i is that number of significant independent variables in the k^{th} unit process that comprise a set of significant independent variables for that process.

It is preferred that m=1, and that linear equations are statistically adequate to describe the relationship between the dependent variable and the independent variables.

It is believed that the regression analysis can be performed on any computer that has a processor that operates at a speed and capacity equal or better than that of an Intel™ 486 processor operating at 33 Mhz speed. However, it is preferred that a computer having a Pentium™ 100 processor, or faster processor, is used. The computer should be programmed with a regression analysis software program. The regression analysis that is available in, for example, Lotus™ 1-2-3, version 5.0, or newer; or in Excel™, version 5.0, or newer; or in SAS, version 6.12, or newer; is suitable for the derivation step of the present method.

7. The value of the ratio of each coefficient to the standard error of the coefficient is determined. If this value is close to zero, the variable corresponding to the coefficient is not a significant variable and should be dropped from the model. To determine whether a coefficient is “close to zero”, the value of the ratio of the coefficient divided by its standard error is compared with tabulated values in a t-test (as described, for example, in Introduction to the Practice of Statistics, by David S. Moore and George P. McCabe, W. H. Freeman & Co. (1989)). As a rule of thumb, if the value of such ratio is greater than 2 in magnitude, the variable is a significant variable and should be maintained in the model.

8. The predictive ability of the regression model is checked by testing its ability to predict the energy use for the validation data set. As used herein, this predictive ability of the model will be termed the “accuracy” of the model. The accuracy of the model is determined by calculating the percent deviation between the actual and predicted energy use on a daily, monthly, or yearly basis—depending upon the type and amount of validation data that is available. The percent deviation is calculated as follows: the actual use of energy for a period (e.g., 1 day) is subtracted from the use predicted by the model. This difference is divided by the predicted use and multiplied by 100 to obtain the percent deviation for that period. For the calculation of the average deviation over multiple individual time periods (e.g., one month of 30 days) the absolute value of the deviation, ¦D¦, for each day is summed over the multiple time periods, divided by the sum of the daily predicted values and multiplied by 100.

The model is tested for predictive accuracy as follows: If the monthly deviation is less than ±5% and the yearly deviation is less than ±1%, the model is accepted. If the monthly deviation is more than ±15%, or the yearly deviation is more than ±1%, the model is rejected. If the model is rejected, one or more additional independent variables for the unit process are identified and selected as described in step 3 and derivation and testing of the model is repeated from step 3 until the model meets the predictive accuracy tests described herein.

9. At this point, it is preferred that the model is reviewed with the owner and/or operator of the process for input and qualitative validation.

10. The predicted energy use values and the actual energy use values is preferably plotted versus time in calendar sequence and the resulting plot should be examined to identify any trend or step-change variations in the predicted versus actual energy values over time. If a trend or step-change deviation of actual versus predicted energy use is apparent, the historical data should be corrected by eliminating data prior to the trend or step-change. The complete regression analysis should be re-run from step 3, using the new, limited data set.

11. The assumption of a linear relationship between each independent variable and the dependent variable (energy use, in this example) is checked by sorting the data by each independent variable in turn and analyzing for any patterns or trends in the deviation between actual and predicted value of the dependent variable. If there is a trend, a multi-part model should be constructed such that the pattern or trend is fit by the new, multi-part model. The coefficients for each independent variable in each model are compared to see if they are significantly different for the several parts and whether the fit is significantly improved by using the multi-part model. If the fit is significantly better for the multi-part model, the multi-part model should be used, rather than the one-part model.

12. The validation data should be inspected for outlying data points—data points that are more than 3-times the standard error of estimate away from the prediction. If any outlying data points are identified, explanations should be sought for the outlying data points and such data points should be eliminated from the database only after failure to correct the data point to a value within 3-times the standard error by checking it against all other records and/or information tending to indicate the true value of the data point (i.e., source documents, memories of operating personnel, operating logs, comparison with other values of the same variable with other points that have similar operating conditions affecting energy use, or the like);

When all energy sources have been modeled for every unit process, all of the unit process models can be incorporated into a model that describes the energy use for the total industrial process per unit of production in terms of significant independent variables. The overall model of the process productivity on the basis of energy use can have the form:

P_{E}=P_{T}/E_{T}

where,

P_{E} is the production of products per unit of process energy use;

P_{T} is the production of products from the process per unit time; and

E_{T} is the energy used by the process per unit time.

and where,

$${E}_{T} = {r}_{B} + {\sum }_{k = 1}^{n} {E}_{k}$$

where:

E_{T} is the energy use for the total industrial process per unit time;

r_{B} is a constant representing the base energy load for the total industrial process per unit time;

n is the total number of unit processes in the industrial process;

k is the identifying numeral for one of the n unit processes and is a positive integer from 1 to n; and

Eₖ is the energy use for the k^{th} unit process per unit time.

The terms r_{B} and r_{BK}, which describe the base energy load for the whole industrial process and the base energy load for one of the unit processes comprising the industrial process, respectively, are defined during the multiple regression model derivation and represent that part of the energy use rate that would be expected if the value of each of the significant independent variables was zero.

In cases where it is desirable to use the production rate (P_{T}) as an independent variable, one can simply use the total energy use of the process per unit time (E_{T}) as the productivity-related parameter.

Likewise, a model of production per unit of time (production rate) can be derived that is of the form:

$${P}_{T} = {s}_{B} + {\sum }_{k = 1}^{n} {P}_{k}$$

where:

P_{T} is the production for the total industrial process per unit time;

S_{B} is a constant representing the total base production for the total industrial process per unit time;

n is the total number of unit processes in the industrial process;

k is the identifying numeral for one of the n unit processes and is a positive integer from 1 to n; and

Pₖ is the production for the k^{th} unit process per unit time, and can be represented by a formula having the form

$${P}_{k} = {s}_{Bk} + {\sum }_{j = 1}^{i} {{s}_{kj} ( {U}_{j} )}^{m}$$

where:

Pₖ is the production for the k^{th} unit process per unit time;

S_{Bk} is a constant representing the base production for the k^{th} unit process per unit time;

Uⱼ is the j^{h} significant independent variable for the k^{th} unit process;

Sₖⱼ is the multiple regression coefficient for the j^{th} independent variable in the k^{th} unit process that provides the best fit in a correlation of the effects of Uⱼ upon Pₖ as determined by multiple regression analysis of historical data;

m is a best fit constant correlating the effect of Uⱼ upon Pₖ as determined by multiple regression analysis of historical data and is a fraction or whole number from 0 to about 3;

j is a number designating one of the significant independent variables in the k^{th} unit process and is an integer from 1 to i; and

i is that number of significant independent variables in the k^{th} unit process that comprise a set of significant independent variables for that process.

It is preferred that m=1, and that linear equations are statistically adequate to describe the relationship between the dependent variable and the independent variables.

In like manner, if the productivity-related parameter is consumables use per unit time, a model can be derived of consumables use per unit of time having the form:

$${C}_{T} = {t}_{B} + {\sum }_{k = 1}^{n} {C}_{k}$$

where:

C_{T} is the consumables use for the total industrial process per unit time;

t_{B} is a constant representing the total base consumables use for the total industrial process per unit time;

n is the total number of unit processes in the industrial process;

k is the identifying numeral for one of the n unit processes and is a positive integer from 1 to n; and

Cₖ is the consumables use for the k^{th} unit process per unit of time, and can be represented by a formula having the form:

$${C}_{k} = {t}_{Bk} + {\sum }_{j = 1}^{i} {{t}_{kj} ( {W}_{j} )}^{m}$$

where:

Cₖ is the consumables use for the k^{th} unit process per unit time;

t_{Bk} is a constant representing the base consumables load for the k^{th} unit process per unit of time;

Wⱼ is the j^{th} significant independent variable for the k^{th} unit process;

tₖⱼ is the multiple regression coefficient for the j^{th} independent variable in the

k^{th} unit process that provides the best fit in a correlation of the effects of Wⱼ upon Cₖ as determined by multiple regression analysis of historical data;

m is a best fit constant correlating the effect of Wⱼ upon Cₖ as determined by multiple regression analysis of historical data and is a fraction or whole number from 0 to about 3;

j is a number designating one of the significant independent variables in the k^{th} unit process and is an integer from 1 to i; and

i is that number of significant independent variables in the k^{th} unit process that comprise a set of significant independent variables for that process.

It is preferred that m=1, and that linear equations are statistically adequate to describe the relationship between the dependent variable and the independent variables.

It should be understood that any one of these models or any combination of two or more of these models can be, and often are, used to describe the changes in various productivity-related parameters for the same process. When a computer is used to calculate the predicted values of each of the dependent variables, they can easily be calculated and reported at any time that the values of the significant independent variables for all of the models are measured.

One important consideration of a model is its validity as a predictive tool. It is important that the model measures and models what it is intended to measure and model, rather than to be simply a good fit of past data. Testing the accuracy of the model is described in step 8, above. The inventors have found that it is preferable to require that the model conform to the standards of accuracy described in step 8, for several reasons. First, the more accurately the model predicts the productivity-related parameter, the less “noise” there is in the calculated values and the easier it is to notice and identify special causes of variation in the process (causes that are not caused by changes in the independent variables) and to take timely corrective action. Second, if the model is to be used as the basis for calculating the amount of energy savings that is actually being achieved, all parties involved can proceed with a higher level of confidence when the model meets the required accuracy standards.

It is also important that the model truly measures the changes in the productivity-related parameter that are caused by changes in the independent variables. This quality can be measured by calculating the correlation coefficient (R). Statistical parameters, such as the value of R-squared (or, R²), are measures of the degree of change in the dependent variable (the productivity-related parameter) that is explained by changes in the independent variables that have been selected for the model. It is believed that if R-squared is lower than 0.6, then it is likely that the model will not accurately predict values of energy use. The advantage gained from having a model that fully explains all, or most, of the degree of change in the dependent variable as a function of changes in the independent variables is that it provides a higher confidence level that the changes predicted by the model truly reflect the change caused by known events. For the purpose of the present invention, it is preferred that the value of R-squared be not under 0.7, more preferred that R-squared be not under 0.8, and yet more preferred that the value of R-squared be not under 0.9.

The inventors have also found that it is important to ensure that co-linearity daignostics are carried out on the independent variables in order to identify and eliminate any possible co-variance problems. Two common methods that can be used for this purpose are found in the statistical analysis program, SAS. Those methods are: (1) a direct method in which, with the dataset open in “Statistical Analysis” mode, the “Statistics, Descriptive, Correlations” test can be used to review correlations between independent variables; and/or (2) a linear regression method, through which a “Correlation Matrix of Estimates” and/or “Covariance Matrix of Estimates” can be selected under the “Statistics” tab in the Linear Regression “Statistics” dialog box. In both methods, the resulting output is a covariance matrix that can be interpreted to determine the existence of co-linearity of the independent variables. It is preferred that co-variant independent variables are eliminated from the model.

Another way to validate a model is to apply the model to future observations during a test period. In other words, to predict the energy use for each day based on the values of the significant independent variables for that same day and then to compare the predicted value with the measured value of energy use. If this can be done over a test period of several months, a good check of the validity of the model can be obtained. However, this method obviously requires additional time for model verification—time that could otherwise be used to improve and benefit from the productivity of the process. Therefore, a preferred method for validating the model is to withhold a portion of the historical data as a validation sample. Then, as described above, a model that was derived on the basis of calibration data can be validated for accuracy by testing its predictive accuracy versus the data of the validation sample.

As mentioned above, it is an important feature of the present invention that the model describes the dependent variable in terms of a validated set of independent variables. As used herein, the terms “validated set of independent variables” refer to that set of independent variables that provides a mathematical model that meets the accuracy tests described in step (8). It is preferred that the validated set of independent variables also includes no unexplained trend or step-change variation as described in step (10); provides a mathematical model that has an R² value (determined as described above) of not less than about 0.6; and is free of co-variance (as described above). It is preferred that the validated set of independent variables further provides a model that has an R² value of not less than about 0.7; more preferred that the validated set of independent variables farther provides a model that has an R² value of not less than about 0.8; and even more preferred that the validated set of independent variables further provides a model that has an R² value of not less than about 0.9.

If an independent contractor has derived the model, it is preferred that the model is presented to the process owner for approval prior to proceeding further with the identification and implementation of changes to improve productivity. Thus, after verification of the model is completed satisfactorily by the contractor, the model is presented to the process owner for approval. If the model is not approved, the model derivation process is preferably begun again at step 3, described above. This iteration is repeated until the model is approved by the owner of the process.

Identifying Modifications to Improve Productivity

One embodiment of the subject method is to identify and implement some type of modification to the process that will improve the productivity of the process. As described above, the productivity of the process is measured, at least in part, by the measurement of a productivity-related parameter. As used herein, the terms “improve the productivity-related parameter” are to be understood to mean a change in a productivity-related parameter that would result in a process change that the owner would find desirable. For example, a decrease in the cost per unit of product, an increased production rate, improved product quality, or reduced emissions, would all be improvements in productivity-related parameters.

It is not critical how modifications to improve the productivity of the process are identified, and modifications can be identified, among other ways, by using standard industrial engineering methodology (e.g., short interval scheduling, audits, observation of the process, load calculations, inventory analysis, or other techniques).

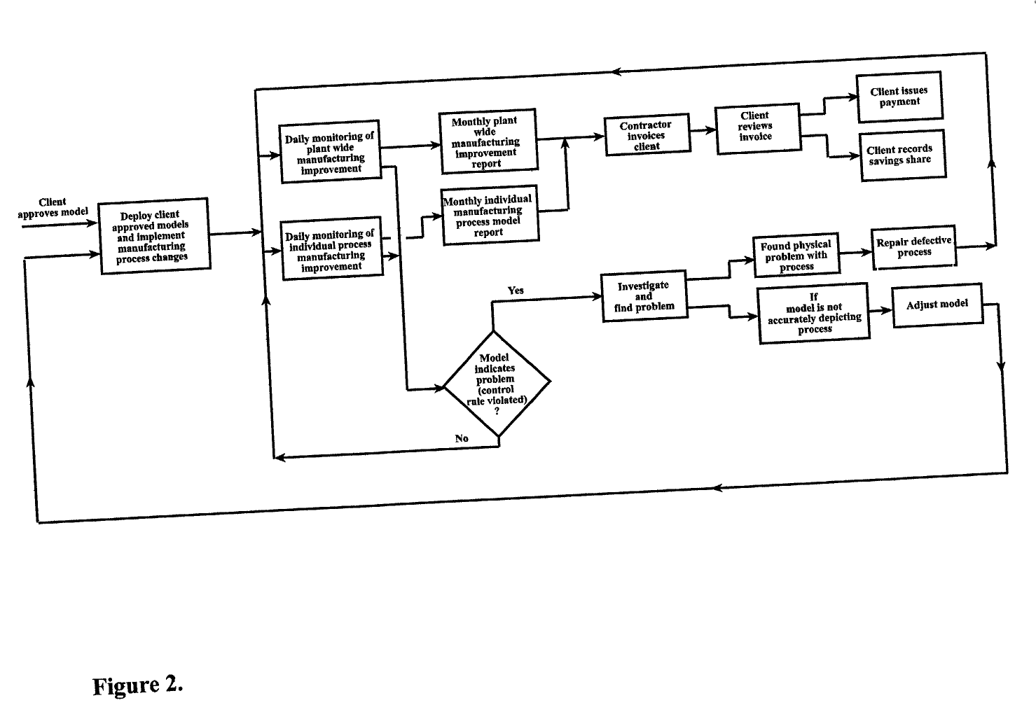

After the statistical mathematical model has been derived and its predictive accuracy has been validated, it can be applied in one or more ways to improve the productivity and/or management of the process. Application of the model is generally illustrated by the diagram shown in FIG. 2. It is preferred that the modification be one that can be made without affecting any independent variable that is included in the validated set of independent variables that appear in the model. When it is said that the modification does not affect such independent variable, what is meant is that the modification itself does not direct that a change be made in one of the independent variables. By way of example, if one of the independent variables in a model of a chemical process is the operating temperature of a reactor, then a modification that proposed changing the reactor temperature would affect the independent variable. This is undesirable because the effect of the modification would be reflected in the predicted value of the productivity-related parameter as well as in the actual measured value. One way to handle such a situation is to remove the affected independent variable from the model. Another way would be to insert a separate term in the model that corrected for any change in the predicted value caused by a change in the particular independent variable.

The modification of the present invention can be any type of modification that will result in an improvement in the productivity of the process. For example, the modification can be in how the process is operated (operational); in how and when the process and process-related equipment is maintained (maintenance); or in the actual equipment used in the process (equipment). Some examples of operational modification (without meaning to be limiting) are a change in a type of raw material or other consumable used; change in a type of fuel used; change in a process variable set point (i.e., raise or lower temperature or pressure); or change in the speed of operation of the process, or a unit process. Some examples of maintenance modifications are changes in when the process is shut down for regular maintenance; or what maintenance is carried out when the process is down. Some examples of equipment modifications are substitutions of newer, more efficient process equipment for older, less efficient, equipment; enlargement or reduction of size of equipment; or addition or deletion of equipment.

One preferred method for identifying a modification to improve the productivity of the process is to use the validated and approved process model in a process simulation mode to test the desirability of various potential modifications. In this method, the model is used to predict productivity improvements (energy savings, for example) that would be obtained as a result of various modifications by simulating the results of proposed modifications of the equipment, materials and/or processing techniques of the process; calculating the cost-effectiveness of each such simulated modification; and comparing the cost-effectiveness of each such modified process with that of the unmodified process. At least one of the simulated modifications found to be cost-effective can then be selected for implementation. Various proposed modifications can even be tested and ranked in order of cost-effectiveness for consideration by management and/or sources of financing. Other management considerations for ranking proposed modifications can include estimated speed of implementation, collateral benefits, ease of completion and acceptability of the modification to operating personnel.

Implementing the Modification

Any modification that has been selected as being one that is cost-effective and one that will produce an improvement in productivity can be implemented by any party. It is preferred, however, that the implementation be done by either the owner, or by an independent contractor. It is more preferred that the modification be implemented by the contractor and that the contractor is the same entity that carried out the analysis and modeling of the process, and even more preferred that the contractor was involved in the identification and selection of potential modifications. An advantage of having the contractor implement the modification is that the contractor is free of the responsibility of operating the process and running the plant, in general. Thus, the contractor can focus all of its energies upon the rapid and accurate design, ordering, construction, shake-down, testing, and start-up of the process after the modification.

Financing the modification

When the contractor makes the modifications, the cost of the modifications can be borne by either the owner or by the contractor. It is preferred, however, that at least some part of the cost of implementing the modification, or modifications, be borne by the contractor. It is more preferred that the contractor bear at least a substantial part of the cost of implementing the modification, and even more preferred that the contractor bear all of the cost of implementing the modification. This is believed to be advantageous because the contractor has carried out the analysis and modeling of the process, and has participated with the owner in the identification and selection of cost-effective modifications to the process, and it is in the best position to know the risks of the modification project and to guard against financial loss that could be caused by such risk. When the modification is one that affects process operation or maintenance, it is preferred that the contractor obtain the financing for, and bear substantially all of the costs associated with implementing the modification. When the modification involves the purchase, installation and use of capital equipment, it is preferred that the contractor obtain financing for purchase of the capital equipment, purchase the capital equipment and act as the initial sole owner of record for the capital equipment.

It is believed that there are several advantages that may be gained when the contractor finances the purchase and installation of capital equipment. The equipment cost can be shown on the balance sheet of the contractor rather than the balance sheet of the process owner. This provides the advantage of allowing the owner to proceed with modifications, which may be highly cost-effective, but are secondary to the primary business of the owner and may be difficult or impossible to justify on the owner's own balance sheet.

The contractor preferably finances the purchase and installation of capital equipment by borrowing funds from a lender. This loan can be of any form that meets the specific needs of the owner and the contractor. It is preferred, however, that the loan is a general obligation loan, and more preferred that the loan is a general obligation, non-recourse loan. As will be described in more detail below, it is preferred that the loan be repaid entirely, or in part, from the savings that result from the modification of the process. Such savings can come from energy savings, increased production rate, reduction in the use of labor or consumables, environmental benefits, quality improvements, or any other measurable value-added benefit, productivity improvement, or combination of two or more productivity improvements, caused by the modification.

Moreover, if the contractor provides such financing for capital equipment for at least two or more separate owners, the contractor can spread the risk of loss for the contractor and for the lender by obtaining the financing required for all of the capital equipment required in all of the projects under a loan to the contractor.

This method of financing provides surprising advantages over conventional loans for the owner, wherein the capital improvement is carried on the balance sheet of the owner. In the novel method, the contractor preferably owns the asset(s) and carries it on its own balance sheet. By such means, termed “off-balance sheet financing” or “performance-based financing”, the owner can keep the resulting capital assets and associated debt burdens off its balance sheet, thereby tapping a new source of capital to fund improvements and strengthen it own financial position from the savings generated from the capital improvement. It is preferred that the loan is secured by a general obligation by the contractor, and more preferred that it be further secured by a security interest in the asset. Such off-balance sheet financing permits the owner to make energy-saving modifications that it otherwise could not undertake due to financial limitations.

It is also desirable to train the operating personnel of the process owner to use and maintain the new equipment, or newly modified operational practices for the process. Because the contractor has been involved in the selection, installation, start-up and initial operation of the equipment and/or operational modification, it is preferred that the contractor provide training of the owner's personnel.

Upon the completion of the process modification, the process is started up and operated with the modification(s), thereby obtaining the benefits of the productivity improvements that result from the modification(s).

Measuring Savings Caused by the Modification

After the modification(s) has been implemented, it is necessary to measure the change in the selected parameter caused by the modification in a manner that will distinguish the effects of the modification from effects caused by other reasons. This is preferably done by determining the difference between a measured value of the productivity-related parameter and a value of the same parameter predicted by the model using measured values of the one or more independent variables.

The model can be used to measure energy savings due to a modification in the operational practice, maintenance or equipment of the process. This is done by measuring the actual value of the energy use, energy use rate, or parameter that is proportional to either of these, for the process (the “actual energy use”), and—at the same time—measuring the actual values for all of the independent variables that appear in the energy use model. The values for the independent variables are used with the model to calculate a predicted energy use that the process would have experienced without the modification (the “predicted energy use”). The energy savings is calculated by comparing the actual energy use with the predicted energy use. The difference between the two indicates the energy savings due to the modification (the “energy savings”).

As mentioned previously, the same approach can be used to calculate the improvement in any productivity-related parameter simply by substituting appropriate parameters for energy in the method described above. By way of example, the savings in consumables use can be measured as: (predicted consumables use)-(actual consumables use)=savings in consumables use or, the savings due to increased production rate can be measured as: (actual production rate)-(predicted production rate)=increase in production rate In case any of the calculated values result in negative numbers, the negative numbers can simply be used as is. For example, negative savings can be plotted on a graph as negative numbers.

Payment for the modification and sharing of savings

The cost of the modification, including the repayment of any loan for the purchase and installation of capital equipment, is to come from productivity improvements due to the modification. It is preferred that such costs are at least partly met by savings derived from the modification (for example, at least about 50% of the costs); more preferred that such costs are at least substantially derived from the modification (for example, at least about 75% of the costs); and most preferred that such costs are derived solely from the modification. When the terms “savings derived from the modification” are used, what is meant is the savings or increased profits, expressed in terms of money, that accrue to the process as a result of the modification. By way of example, these could be energy savings, savings in the amount and type of raw materials or consumables or labor, environmental benefits, quality improvements, or increased production rate, or the like.

It is the intent of the novel method that not only the costs of the modification are met solely by savings derived from the modification, but that the savings actually exceed the costs. The excess of the savings over the costs of the modification represent the economic incentive to both the contractor and the owner to undertake the project and is preferably shared between the two parties. However, since the subject method advantageously provides a method for risk-sharing between the contractor and the owner, it is preferred that any negative savings (i.e., financial losses) are shared between the contractor and the owner.

The sharing of savings between the owner and the contractor can start as soon as savings resulting from the modification can be identified. The savings can be shared between the owner and the contractor in any way they mutually decide. In some cases, it is preferred tha the party who paid the costs of implementing the modification recover from the savings derived from the modification an amount equal to repayment of its costs; then the remainder of the savings are shared between the owner and the contractor on the basis of a predetermined proportion.

One method for sharing this value is to share between the participating parties on an equal basis for a negotiated period of time. Another method for sharing is where a negotiated portion of the excess of the value of the change in the productivity-related parameter caused by the modification over the cost of the modification is shared between the participating parties. In any case, it is preferred that the party bearing the cost for the modification recover such cost prior to any sharing of savings.

In some cases, implementation of a modification to the process includes the purchase and installation of capital equipment. By “capital equipment”, what is meant is equipment which the Internal Revenue Service would require to be capitalized. This includes most larger or more expensive pieces of equipment and/or equipment having a useful life of over one year. When capital equipment is purchased, the purchaser is normally required to show the equipment on its balance sheet. Thus, if the process owner purchases capital equipment, the cost is normally shown on its balance sheet. However, if the contractor purchases any capital equipment that is required for the modification, the cost appears on the contractor's balance sheet rather than on the balance sheets of the owner. This is advantageous because it permits the process owner to obtain and take advantage of the new capital equipment without the burden of the purchase on its balance sheet—thus, freeing its own capital for other projects and increasing overall return on assets.

Using statistical productivity improvement models as management tools

Many industrial plants have extensive information gathering systems that report data for their processes. Some of this data is reported for productivity-related parameters, such as energy use, consumables use, labor use, production rate, and the like. However, what is lacking is an accurate standard against which to compare productivity. Often what is used is an accounting standard, such as an average of past performance. However, such a standard does not take into account changes in production levels, product mix, weather conditions, operation of different pieces of equipment in the process, and the like—all of which can affect productivity. Compared to this standard, measured productivity can be either positive or negative, but the standard provides no basis for determining whether the measured productivity is good or bad. Such a situation puts management in the position of solving non-existent problems, or ignoring real performance deterioration.

It has been found that the statistical productivity models of the present invention can be used in a surprising way to serve as a basis for a reliable decision support system for improved management of process productivity. The productivity model, or models, can be applied to the measured values of the independent variables —as soon as they are available—to provide an almost instantaneous comparison of the process productivity with the productivity that would have been expected without present improvements or modifications to the process. In other words, the model indicates whether process productivity is actually improving or degenerating.

The general procedure for using the models as management tools is shown in FIG. 2. Following approval of the proposed modification(s) by the owner, the contractor and the owner use the model(s) to monitor the improvement(s) due to the implemented modifications to the process. This monitoring is performed by using models that cover the total industrial process, or even more than one process, if present in the industrial plant, and also by using the models for each of the unit processes. Data for each dependent variable and each independent variable in the validated set is collected and preferably segregated into months. From these monthly data sets, monthly reports can be generated. The monthly reports indicate—for each day of the month—the cumulative savings resulting from the implemented modifications, and also, in the case of a monthly plant-wide report, serve as the basis for sharing the resulting cost savings by which the contractor is paid (as described above).

The application of certain control rules to the daily data, as shown in FIG. 2, and defined below, indicate when monitored data reveals processes to be outside statistical control, at which point various remedial measures, as indicated in FIG. 2, can be quickly taken.

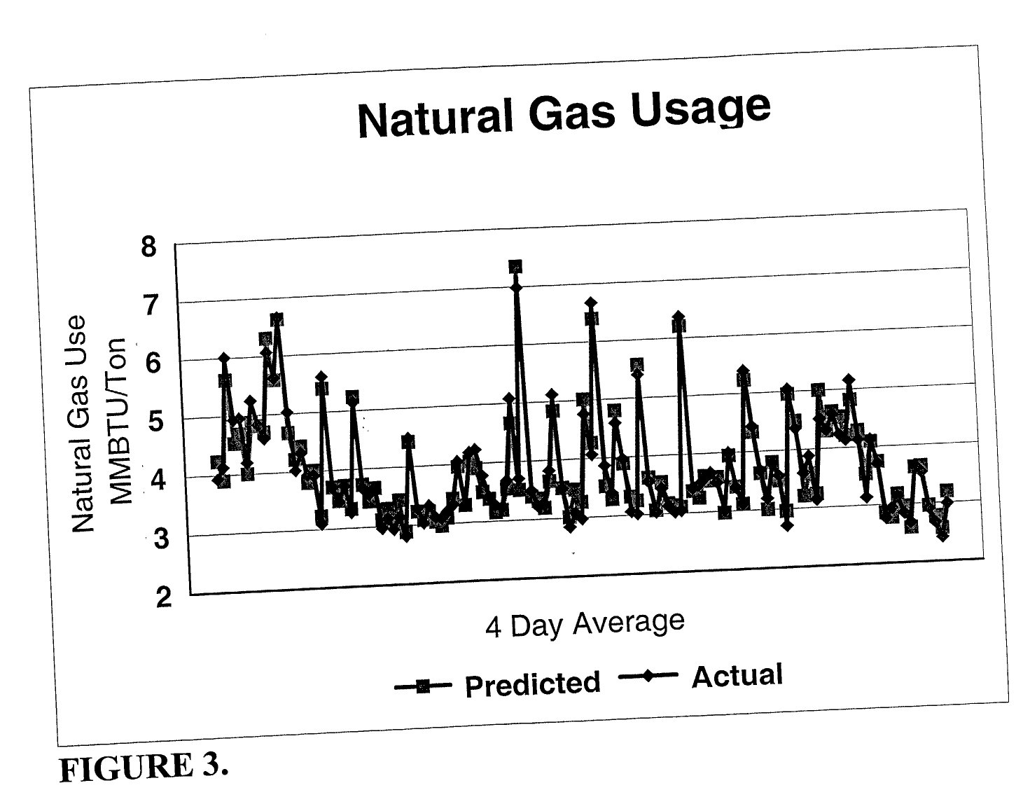

One specific way that the models are used as a management tool is to plot the productivity-related parameter versus time in the form of a daily report. If the value of the productivity-related parameter predicted from each day's values of the independent variables is also plotted on the same chart, or otherwise compared against the actual value of the parameter, the positive or negative deviation from the predicted value can be readily envisioned. Moreover, if data from several weeks or months is included in the chart, any trends in the productivity can also be seen. This can be seen in FIG. 3, where daily energy use is plotted versus time along with the predicted value of energy use and the value of the energy savings. The plot provides a clear indication of what actual energy use was for the previous 24 hours and what it should have been—given the operating conditions, production rates and weather conditions that prevailed. The application of simple statistical control tools to plots such as this, as will be discussed in more detail below, can provide an accurate means of determining when to make a process change or when to analyze the process further to solve a problem or take advantage of an opportunity.

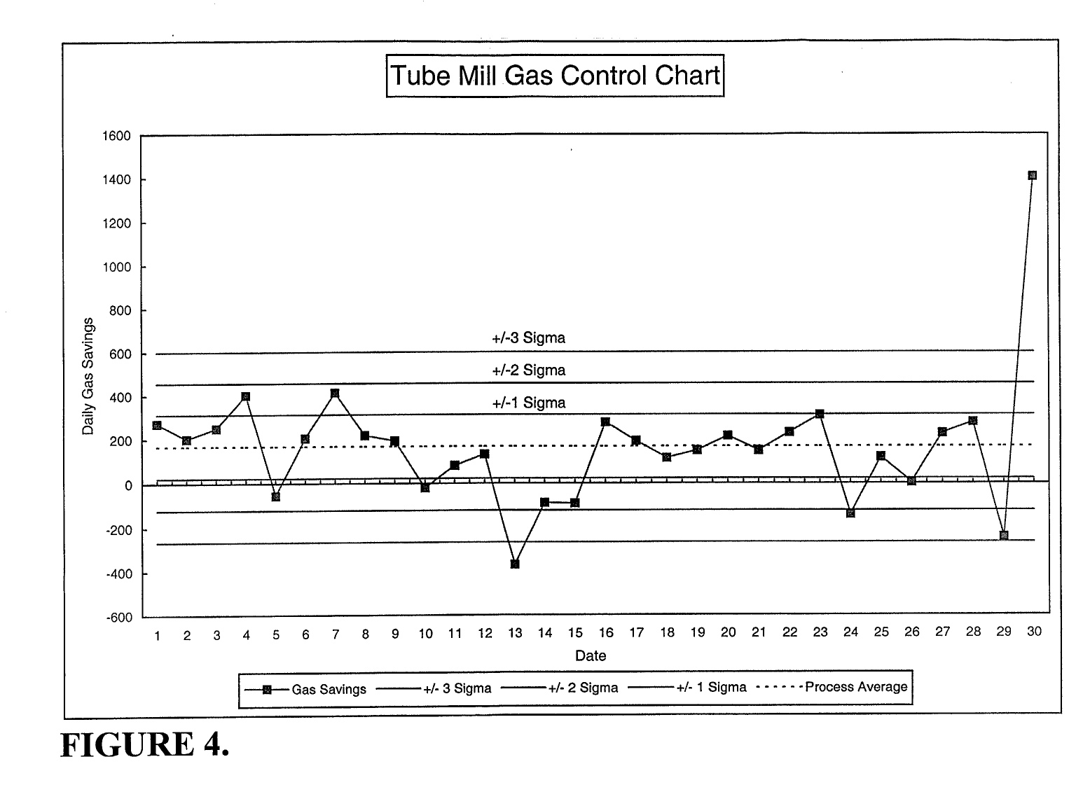

One preferred method for the analysis of data of the type illustrated in FIG. 4 is analysis according to tests such as, for example, those sometimes known as the “Western Electric Zone Tests”. (See, e.g. Understanding Statistical Process Control, by Donald Wheeler and David Chambers, SPC Press (1992), for more information). One embodiment of the application of these tests to the data of FIG. 4 is to examine the difference between each day's value of the productivity-related parameter and the predicted value of that parameter according to four rules. If any point results in a violation of one of these rules, then the process must be investigated to determine what special cause of variability has occurred to bring the process out of statistical control. The rules are as follows:

Rule 1: Any point more than three standard deviations from the process average;

Rule 2: Any two out of three successive points on the same side of, and more than two standard deviations from, the process average;

Rule 3: Any four out of five successive points on the same side of, and more than one standard deviation from, the process average; or

Rule 4: Any eight successive points on the same side of the process average.

It is believed that if any one of these patterns of productivity variability occurs, it is an indication that there is a special cause of variability that is not accounted for by the productivity model. Usually these special cases result in deterioration of the productivity of the process, but occasionally a change occurs that results in improvement. In any case, it is important to identify either productivity deterioration or improvement for the process to support timely correction or making a transient improvement permanent.

The same tests as listed above can also be used to determine the effect of a planned and consciously implemented change to the process as a part of a test. If the change does not result in a rule violation, then the change did not affect the process.

Once the industrial process of interest has achieved a new, more efficient, level of productivity through application of the present method, it is preferred that a new mathematical model is derived and the entire subject method is repeated. The new model then becomes the standard for determining the performance of the improved process.

The following examples describe preferred embodiments of the invention. Other embodiments within the scope of the claims herein will be apparent to one skilled in the art from consideration of the specification or practice of the invention as disclosed herein. It is intended that the specification, together with the examples, be considered exemplary only, with the scope and spirit of the invention being indicated by the claims which follow the examples.

### EXAMPLE 1

This illustrates the derivation of a statistical mathematical model of the natural gas consumption in a forging operation in the Midwestern United States.

The model equation for natural gas consumption for an industrial forging operation in the upper Midwestern United States was obtained by applying the following procedures:

Historical values of gas consumption for the process were obtained from daily energy reports for the period April of one year through January of the next year, giving a total of 304 data points. Production and weather data for the same period was gathered from daily production reports and from Midwest Climate Center reports for Chicago's Midway Airport, respectively.

A multiple regression analysis (using the multiple linear regression routine provided by Lotus™ 1-2-3, release 5) for the following independent variables:

Production (Pounds)
Heating degree days (HDD)
Production work days (PWD)
Office work days (OWD)

This analysis gave an equation of the form:

E_{T}=2119+0.0287*(Pounds)+177.8*(HDD)+9473*(PWD)+2787*(OWD)

where,

E_{T} =total natural gas usage.

The R-squared value for this analysis was 0.8154 and the average day-to-day variation was 16.87%. Taken over the monthly periods for this historical data, this gave a month-to-month variation of about 8%, which was considered to be too high for acceptable accuracy (no more than 5% is considered acceptable for monthly variation).

The data was then sorted by day of the week and an attempt was made to see if there were any significant trends. (For example, it was thought that a start-up on Monday after a week-end would show higher gas usage.) This analysis showed that there was a systematic underprediction of gas use on Saturdays when there was no production. Upon questioning the production management, it was found that normally there was a cleaning crew on duty part of the day on Saturday and it was necessary for the boiler to be operated during this time. If Saturday was a production day, this did not make a significant difference, but the gas use was significantly different from Sundays, when the boiler was not operated. As a result of this finding, non-production Saturdays was added as an independent variable. This regression improved the R-square slightly from 0.8154 to 0.8175 and reduced the day-to-day variation to 15.9%—which was still too high.

Another complicating factor in this analysis was the fact that the parts produced in this process varied widely in size, from a few pounds to more than 1,000 lbs. It was decided to sort production by size of part produced. Initially, production was sorted into six groups: up to 25 lbs; 25-50 lbs; 50-100 lbs; 100-200 lbs; 200-500 lbs; and more than 500 lbs. A regression analysis using these groupings yielded unstable results with very unreliable coefficients. The number of groupings was reduced gradually until just two groups were used. A finer separation by part size did not improve the correlation. The two groupings that were used were parts larger than 100 lbs, but less than 500 lbs, and parts larger than 500 lbs. It was found that production of parts smaller than 100 lbs (initial size) did not affect gas use. This analysis improved R-square to 0.82, but did not materially affect the day-to-day error.

Throughout the analysis, the months of May and June of the first year were consistently underpredicted, with actual gas use being considerably above the model predictions. Review of the energy reports showed that a different boiler was in use during much of this period. As a result of this, operation of this second boiler was included as an independent variable in the regression analysis. This addition improved the R-square from 0.82 to 0.8452, with a subsequent reduction in day-to-day error to 15.4%.

Frequently, the relationship between the measured (dependent variable) and the factors affecting it are non-linear. The technique used to test for linearity is to sort the data—using each independent variable in turn as a sorting key. The variables amenable to this sorting were daily production quantities and daily heating degree days. No systematic trend in the deviation between the model and the actual gas use was determined for production levels, but a significant difference was found at very high degree days. The practical reason for this is that when it is extremely cold, the boiler is run around the clock to prevent problems with frozen pipes; the normal practice being to shut the boiler down at the end of a production day. As a result, gas use during a very cold day is substantially higher than normal. The systematic deviation was averaged for days greater than 45 degree days and found to be approximately 8,000 therms more than the model prediction.

In order to apply this correction to the model, the daily actual gas use was reduced by 8,000 therms for any day with more than 50 heating degree days, and the regression analysis was rerun using the adjusted actual gas use as the dependent variable. This regression showed an R-square of 0.8703 and an average day-to-day variation of 13.9%—a considerable improvement.

A model based on regression analysis can be made to fit a set of historic data to almost any degree of accuracy, given enough independent variables. This accuracy does nothing to indicate how good the model is as a predictive tool. To measure the model's usefulness as a predictor, it must be applied to a set of data for the same process, which was not included in the data used to derive the model.

In this case, the model was applied to data from Feb. and Mar. of the second year. Feb. fit quite well—with the model underpredicting actual use by 5.7%, but Mar. was not a good fit with the model—overpredicting by 16.5%. When this was discussed with the production management, they recognized that a large piece of process equipment had been shut down on Mar. 2, of the second year for an extensive rebuild. For the present purposes, this piece of equipment will be referred to as a Steam User. Since no data was available specifically for the energy load related to the Steam User, it was decided to calculate the average difference between predicted and actual gas use for the 30 days during Mar. when this piece of equipment was down. This was calculated at 3026 therms per production day. When this information was added to the model, the final model equation had the form:

E_{T}=1906*B+5944*PWD+3026*SUD+1900*NPS+0.04684*P1+ 0.02770*P2+2857*OWD+163.9*HDD+3646*Z+8,000

where:

E_{T}=Total gas use during the period (Therms);

B=Number of days in the period;

PWD=Number of production days in the period;

SUD=Days of operation of Steam User;

NPS=Number of non-production Saturdays in the period;

P1=Production pounds for units of greater than 100 lbs, but less than 500 lbs;

P2=Production pounds for units of greater than 500 lbs;

OWD=Office workdays in the period;

HDD=Heating degree days in the period;

Z=Days of operation of second boiler.

8,000 therms was added for any day having HDD 50 or over, but was not added for any day having HDD under 50.

The R-square value for this model is 0.894 and the monthly deviation was less than 5%, both of which are within the accuracy required of the model.

### EXAMPLE 2.

This example illustrates the modification of the control system of a tube mill furnace and the sharing of savings obtained as a result of the modification.

A statistical mathematical model was derived for a metal tube manufacturing process by the method illustrated in Example 1. As a result of process simulations of a number of potential process modifications, it was found that the productivity of the system could be significantly improved by modifying the gas and air control system of the furnace and thereby saving energy. The system upgrade involved replacing an Askania ratio control system with an electronic system using an existing programmable limit controlled PLC-5/25. The new system was designed to sense combustion air flow on the downstream side of the furnace recuperators, eliminating errors due to recuperator leakage. Gas and air flow measurements were temperature compensated and gas flow measurement was also pressure compensated.

Air flow was measured by a set of two pitot tubes in each zone. Natural gas flow was measured using an orifice plate in at the same location as an existing orifice plate. The flow signals (differential pressures) were sensed locally, eliminating the need for impulse lines leading to the pulpit. All input and output features outside of the pulpit were directed through a remote I/O enclosure located near the steam superheater control box.

The existing natural gas valve actuators and stack damper actuator were used, but gas flow, pressure and temperature sensors, and combustion air flow, temperature and air actuators were new. The existing furnace temperature and pressure sensors and gas actuators were used.

Operator interface was via a flat-panel LCD Panel View 550 unit with keypad entry. The control algorithm provides the option of automatic gas and air flow driven from user-supplied zone temperature inputs, or user-supplied air or gas flow with automatic ratio control. The algorithm also provides cross-limited, cascade control. The system also has the capability of displaying instantaneous energy usage rate (MMBTU/TON) on the Panel View screen for instantaneous feedback of energy use rate to the operators.

Role of the Contractor and the Owner (Client):

The contractor provided the equipment as listed below in Table 1. The contractor also provided programming and engineering services and engineering support throughout the installation and implementation of the modification as shown in Table 2.

The installation of the combustion air pitot tubes involved technical support from the manufacturer and labor from the client as shown in Table 3. All other transmitters were mounted and installed by the client. All cables and conduits were installed using client labor. All client labor costs was paid by the contractor.

TABLE 1
List of new components purchased and installed in the modification.

| QUAN- | | | TOTAL |
|---|---|---|---|
| TITY | ITEM | PRICE | PRICE |
| 4 | Rosemount 1151 DP, 0-25″ wc | $1,159.00 | $4,636.00 |
| 3 | Rosemount 3051 CD 0-0.5″ wc | 1,598.00 | 4,794.00 |
| 1 | Pyromation RTD and Transmitter | 613.00 | 613.00 |
| 6 | Superior Flo 1005 series pitot tubes | 1,260.00 | 7,560.00 |
| 3 | Orifice plates (natural gas) | 309.00 | 927.00 |
| 3 | Tru-Tork MATIC TA400 damper | 1,761.00 | 5,283.00 |
| | actuators | | |
| 1 | Allen-Bradley 1771-IFE 16 point | 1,087.00 | 1,087.00 |
| | analog input cards | | |
| 2 | Allen-Bradley 1771 OFE2 4 point | 1,087.00 | 2,174.00 |
| | output cards | | |
| 1 | Allen-Bradley 1771-IA Mini AC/DC | 250.58 | 250.58 |
| | (120 V) input card | | |
| 1 | Allen-Bradley 1771-OA AC/DC | 350.58 | 350.58 |
| | (120 V) output card | | |
| 1 | Panel View 550 Operator Terminal | 1,695.00 | 1,695.00 |
| 1 | Configuration software for Panel | 495.00 | 495.00 |
| | View | | |
| 1 | Allen-Bradley 1771-P4S power | 460.63 | 460.63 |
| | supply | | |
| 1 | Allen-Bradley 1770-SC Data | 184.25 | 184.25 |
| | Highway station | | |
| 1 | Allen-Bradley 1771-ASB Remote I/O | 847.55 | 847.55 |
| | Adapter | | |
| 1 | NEMA-4 30″ × 24″ × 10″ enclosure | 265.00 | 265.00 |
| 1 | 30″ × 24″ panel | 35.00 | 35.00 |
| 1 | Allen-Bradley 1771-A2B 64 I/O | 305.86 | 305.86 |
| | Rack Assembly | | |
| 3 | Current isolators for single input card | 225.00 | 675.00 |
| | cables and conduit | | |
| TOTAL | | | $32,638.69 |

TABLE 2
Contractor labor expended during the modification.

| FUNCTION | MANHOURS | RATE | TOTAL CHARGE |
|---|---|---|---|
| Programming | 200 | $80/manhour | $16.000.00 |
| Engineering | 120 | $80/manhour | $3,600.00 |
| Installation support | 120 | $60/manhour | $3,600.00 |
| TOTAL | | | $23,200.00 |

TABLE 3
Client labor expended during the modification.

| | MAN- | | |
|---|---|---|---|
| FUNCTION | HOURS | RATE | TOTAL CHARGE |
| Electrician | 708 | $42.60/manhour | $32,035.00 |
| Pipefitters | 130 | $42.60/manhour | 5,538.00 |
| Instrument repair | 80 | $42.60/manhour | 3,408.00 |
| TOTAL | | | $40,981.00 |

Results:

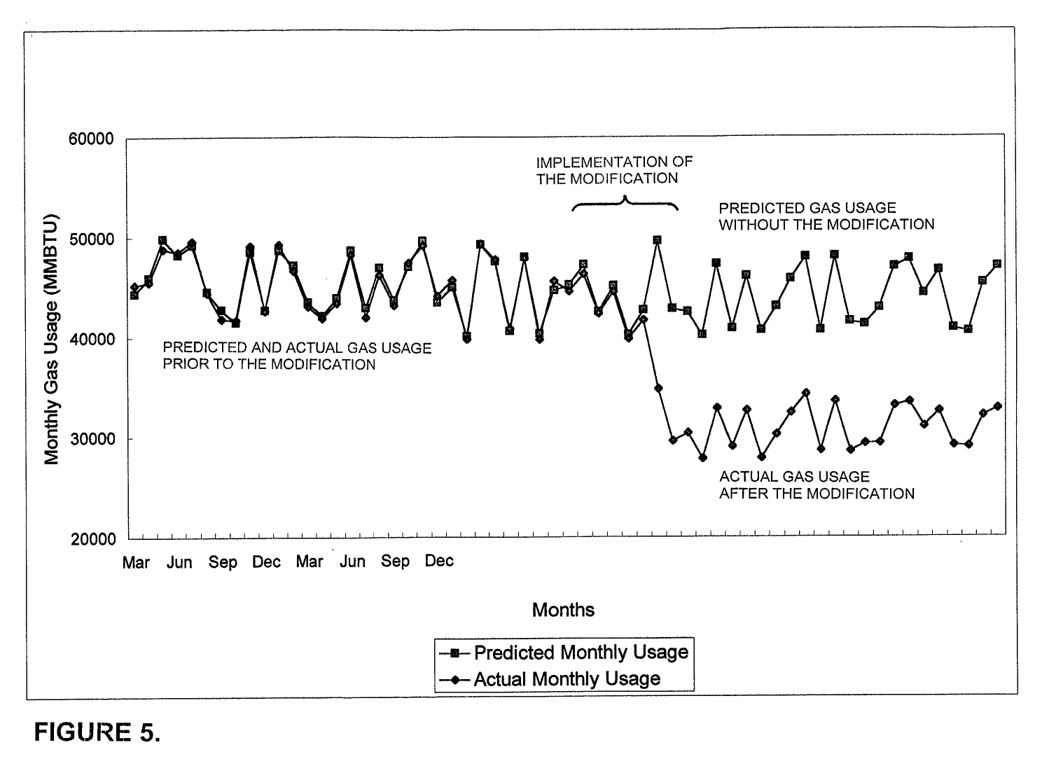

The tube mill furnace controls project was commenced in Mar. of the project year and completed in May of that same year, with full operation achieved in Jun. Fuel use, which had averaged more than 45,000 MMBTU per month, was reduced to an average of slightly more than 32,000 MMBTU per month. The actual gas usage rates before and after the implementation of the modification are shown in FIG. 5, along with the gas usage rate predicted by the mathematical model for the system had the modification not taken place (the predicted rate). Average natural gas cost over the shared savings period was $2.71/MMBTU and the savings were shared equally between the client and the contractor. The total investment for this project was approximately $122,000 —all of which was paid by the contractor. Total contractor billings to the client over the shared savings period were about $425,000. During the contract period, this project provided the client with a net benefit of $425,000 and the contractor with a net benefit of $303,000.

All references cited in this specification (including without limitation all citations to journals, periodicals, texts, manuscripts, patents, published patent applications, and the like) are hereby incorporated by reference. The discussion of references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions without departing from the scope of the invention, it is intended that all matter contained in the above description and shown in the accompanying drawings shall be interpreted as illustrative and not in a limiting sense.

what is claimed is:

1. A method for improving the productivity of an industrial process comprising the steps of: deriving with a computer a statistical mathematical model that describes a productivity-related parameter for the industrial process in terms of a validated set of independent variables; identifying a modification to improve the productivity of the process; implementing the modification; and measuring the change in the productivity-related parameter caused by the modification by determining the difference between a measured value of the parameter and a value of the parameter predicted by the model using measured values of each of the independent variables of the validated set.

2. The method as set forth in claim 1, where the industrial process includes process equipment having a size and in which an amount of capital is invested, and which process uses consumables, energy and labor for the production of one or more products; wherein the productivity-related parameter is production per unit of time, production per unit of labor, production per unit of energy use, production per unit of consumables use, production per unit of process equipment size, production per unit of capital invested in the process, energy use per unit time, consumables use per unit time, or the inverse of any of these.

3. The method as set forth in claim 2, wherein the modification to improve the productivity of the process is carried out without affecting an independent variable that is included in the validated set.

4. The method as set forth in claim 2, wherein the productivity-related parameter is energy use per unit time.

5. A method as set forth in claim 4, wherein the step of deriving with a computer a statistical mathematical model that describes a productivity-related parameter for the industrial process in terms of a validated set of independent variables comprises deriving with a computer a model of production per unit of process energy use having the form:
$${E}_{T} = {r}_{B} + {\sum }_{k = 1}^{n} {E}_{k}$$
where:
E_{T} is the energy use for the total industrial process per unit time;
r_{B} is a constant representing the base energy load for the total industrial process per unit time;
n is the total number of unit processes in the industrial process;
k is the identifying numeral for one of the n unit processes and is a positive integer from 1 to n; and
Eₖ is the energy use for the k^{th} unit process per unit time.

6. A method as set forth in claim 5, wherein Eₖ is derived for each of the unit processes from a formula having the form:
$${E}_{k} = {r}_{Bk} + {\sum }_{j = 1}^{i} {{r}_{kj} ( {V}_{j} )}^{m}$$
where:
Eₖ is the energy use for the k^{th} unit process per unit time;
r_{Bk} is a constant representing the base energy load for the k^{th} unit process per unit time;
Vⱼ is the j^{th} significant independent variable for the k^{th} unit process;
rₖⱼ is the linear regression coefficient for the j^{th} independent variable in the k^{th} unit process that provides the best fit in a correlation of the effects of Vⱼ upon Eₖ as determined by multiple regression analysis of historical data;
m is a best fit constant correlating the effect of Vⱼ upon Eₖ as determined by multiple regression analysis of historical data and is a fraction or whole number from 0 to about 3;
j is a number designating one of the significant independent variables in the k^{th} unit process and is an integer from 1 to i; and
i is that number of significant independent variables in the k^{th} unit process that comprise a set of significant independent variables for that process.

7. The method as set forth in claim 2, wherein the productivity-related parameter is production of products per unit time.

8. The method as set forth in claim 7, wherein the step of deriving with a computer a statistical mathematical model that describes a productivity-related parameter for the industrial process in terms of a validated set of independent variables comprises deriving with a computer a model of production per unit of time having the form:
$${P}_{T} = {s}_{B} + {\sum }_{k = 1}^{n} {P}_{k}$$
where:
P_{T} is the production for the total industrial process per unit time;
S_{B} is a constant representing the base production for the total industrial process per unit time;
n is the total number of unit processes in the industrial process;
k is the identifying numeral for one of the n unit processes and is a positive integer from 1 to n; and
Pₖ is the production for the k^{th} unit process per unit time.

9. A method as set forth in claim 8, wherein Pₖ is derived for each of the unit processes from a formula having the form:
$${P}_{k} = {s}_{Bk} + {\sum }_{j = 1}^{i} {{s}_{kj} ( {U}_{j} )}^{m}$$
where:
Pₖ is the production for the k^{th} unit process per unit time;
S_{Bk} is a constant representing the base production for the k unit process per unit time;
Uⱼ is the j^{th} significant independent variable for the k^{th} unit process;
sₖⱼ is the multiple regression coefficient for the j^{th} independent variable in the k^{th} unit process that provides the best fit in a correlation of the effects of Uⱼ upon Pₖ as determined by multiple regression analysis of historical data;
m is a best fit constant correlating the effect of Uⱼ upon Pₖ as determined by multiple regression analysis of historical data and is a fraction or whole number from 0 to about 3;
j is a number designating one of the significant independent variables in the k^{th} unit process and is an integer from 1 to i; and
i is that number of significant independent variables in the k^{th} unit process that comprise a set of significant independent variables for that process.

10. The method as set forth in claim 2, wherein the productivity-related parameter is consumables use per unit time.

11. The method as set forth in claim 10, wherein the step of deriving with a computer a statistical mathematical model that describes a productivity-related parameter for the industrial process in terms of a validated set of independent variables comprises deriving with a computer a model of consumables use per unit of time having the form:
$${C}_{T} = {t}_{B} + {\sum }_{k = 1}^{n} {C}_{k}$$
where:
C_{T} is the consumables use for the total industrial process per unit time;
t_{B} is a constant representing the base consumables use for the total industrial process per unit time;
n is the total number of unit processes in the industrial process;
k is the identifying numeral for one of the n unit processes and is a positive integer from 1 to n; and
Cₖ is the consumables use for the k^{th} unit process per unit time.

12. The method as set forth in claim 11, wherein Cₖ is derived for each of the unit processes from a formula having the form
$${C}_{k} = {t}_{Bk} + {\sum }_{j = 1}^{i} {{t}_{kj} ( {W}_{j} )}^{m}$$
where:
Cₖ is the consumables use for the k^{th} unit process per unit time;
t_{Bk} is a constant representing the base consumables load for the k^{th} unit process per unit of time;
Wⱼ is the jth significant independent variable for the k^{th} unit process;
tₖⱼ is the multiple regression coefficient for the j^{th} independent variable in the k^{th} unit process that provides the best fit in a correlation of the effects of Wⱼ upon Cₖ as determined by multiple regression analysis of historical data;
m is a best fit constant correlating the effect of Wⱼ upon Cₖ as determined by multiple regression analysis of historical data and is a fraction or whole number from 0 to about 3;
j is a number designating one of the significant independent variables in the k^{th} unit process and is an integer from 1 to i; and
i is that number of significant independent variables in the k^{th} unit process that comprise a set of significant independent variables for that process.

13. The method as set forth in claim 2, wherein a set of historical operating data has been collected for values of the productivity-related parameter and for values of one or more independent variables and such set of historical data is divided into a correlation portion and a validation portion; and the statistical mathematical model is 5 derived by using the correlation portion; and wherein a validated set of independent variables is selected as that set of independent variables that provides a statistical mathematical model having a monthly deviation of no larger than ±5% when tested against the data in the validation portion.

14. The method as set forth in claim 13, wherein the validated set of independent variables is selected as that set of independent variables that provides a statistical mathematical model having a yearly deviation of no larger than ±1% when tested against the data in the validation portion.

15. The method as set forth in claim 14, wherein the statistical mathematical model has an R-squared value of not under 0.6.

16. The method as set forth in claim 15, wherein the statistical mathematical model has an R-squared value of not under 0.7.

17. The method as set forth in claim 16, wherein the statistical mathematical model has an R-squared value of not under 0.8.

18. The method as set forth in claim 17, wherein the statistical mathematical model has an R-squared value of not under 0.9.

19. The method as set forth in claim 17, wherein the value of m=1.

20. The method as set forth in claim 1, wherein the step of identifying a modification to improve the productivity of the process comprises the steps of: using the model to predict productivity changes by simulating the results of one or more proposed modifications of the process; and selecting at least one of the proposed modifications on the basis of the degree to which the predicted productivity changes are an improvement to the process productivity.

21. The method as set forth in claim 19, wherein the step of implementing the modification comprises the purchase and installation of capital equipment.

22. The method as set forth in claim 21, wherein the industrial process is owned by an owner having a balance sheet and the capital equipment is purchased and installed by a contractor.

23. The method as set forth in claim 22, wherein funds for the purchase and installation of the capital equipment are obtained by the contractor under a loan from a lender, thereby providing that the debt does not appear on the balance sheet of the owner.

24. The method as set forth in claim 23, wherein the loan is a general obligation loan.

25. The method as set forth in claim 19, further comprising the step of calculating the value in terms of money of the change in the productivity-related parameter caused by the modification.

26. The method as set forth in claim 25, wherein the industrial process is owned by an owner and at least some part of the cost of the modification has been funded by contractor.

27. The method as set forth in claim 26, wherein the industrial process is owned by an owner and at least a substantial part of the cost of the modification has been funded by contractor.

28. The method as set forth in claim 27, wherein the industrial process is owned by an owner and all of the cost of the modification has been funded by contractor.

29. The method as set forth in claim 28, wherein the savings that result from the modification is shared between the owner and the contractor.

30. The method as set forth in claim 29, wherein the excess of the value of the change in the productivity-related parameter caused by the modification over the cost of the modification is shared between the owner and the contractor on an equal basis for a negotiated period of time.

31. The method as set forth in claim 29, wherein a negotiated portion of the excess of the value of the change in the productivity-related parameter caused by the modification over the cost of the modification is shared between the owner and the contractor.

32. The method as set forth in claim 2, further comprising measuring the value of the productivity-related parameter and the independent variables of the validated set on a regular basis; and plotting the measured value of the productivity-related parameter, the value of the productivity-related parameter predicted by the model using the measured values of the independent variables; and the difference therebetween, as a function of time, thereby providing a tool to track and visually present the impact of the modification.

33. The method as set forth in claim 2, further comprising measuring the value of the productivity-related parameter and the independent variables of the validated set on a regular basis; calculating the value of the productivity-related parameter predicted by the model using the measured values of the independent variables; where the difference therebetween is a measure of the impact of the modification upon the productivity-related parameter; and determining whether the process is statistically out of control by testing the impact versus time data against Western Electric Zone Tests.

34. The method as set forth in claim 2, further comprising measuring the value of the productivity-related parameter and the one or more independent variables on a regular basis; and plotting the measured value of the productivity-related parameter, the value of the productivity-related parameter predicted by the model using the measured values of the independent variables of the validated set; and the difference therebetween, as a function of time, thereby providing a tool to help identify any trend of the productivity-related parameter due to the impact of the modification.
